(19) United States
(12) Patent Application Publication
(10) Pub. No.: US 2018/0193970 A1
(43) Pub. Date: Jul. 12, 2018

(54) ROTARY TOOL FOR REMOVING MATERIAL FROM A PLASTIC PART

(71) Applicant: Compagnie Plastic Omnium, Lyon (FR)

(72) Inventor: David TRESSE, Saint Andre de Corcy (FR)

(73) Assignee: Compagnie Plastic Omnium, Lyon (FR)

(21) Appl. No.: 15/107,140

(22) PCT Filed: Dec. 22, 2014
(86) PCT No.: PCT/FR2014/053498

§ 371 Date: Jun. 22, 2016

(30) Foreign Application Priority Data
Dec. 24, 2013 (FR) 1363566

(51) Int. Cl. B24B 9/20; B24B 27/00; B25J 11/00; B29C 37/02; B23B 35/00; B23C 3/00

(52) U.S. Cl. CPC B24B 9/20; B24B 27/0038; B23C 3/00; B29C 37/02; B23B 35/00; B25J 11/006

(57) ABSTRACT

System for removing material from a plastic part, comprising a rotating spindle provided with abrasive means. The rotating spindle includes a non-abrasive section, which can form a radial stop for the system on a guide edge. The system includes driving means for rotating the abrasive means connected to the rotating spindle; and a mechanical means for linking to a robot, the mechanical linkage being of type ball joint with pin.

This invention relates to the field of manufacturing plastic parts by moulding.

Various methods for moulding plastic parts are known:
thermoforming (compression with a thermoplastic material);
injection (for thermoplastic materials); and
compression (thermosetting materials such as SMC);

Numerous methods, such as the conversion of SMC by compression, may generate burrs on the edges of the part, due to flow of plastic material.

These burrs must be removed from the plastic part during the finishing phase. This operation is called “deburring”.

Deburring is currently carried out manually by operators who sand the burr.

This long, manual method creates numerous health problems, such as musculoskeletal disorders, due to the prolonged use of vibrating sanders. In addition, the very fine dust generated by sanding clogs the lungs and the machines, requiring a complex installation with suction and sealing systems in particular.

No satisfactory automatic solution is currently available to automate this operation.

One of the major difficulties is that removing the burr is a delicate operation requiring touch, since due to the fact that the burr is very thin (from 0.1 to 0.3 mm) and not constant, the edge is quickly damaged if the operation is not adapted to the burr.

This need to “touch” is not compatible with an automatic method which, by definition, is difficult to adapt to individual cases.

The invention aims to supply equipment used to automatically remove material from a plastic part, such as by deburring or milling. This system for removing material comprises a rotating spindle provided with abrasive means. The rotating spindle includes a non-abrasive section, which can form a radial stop for the system on a guide edge. The system also includes driving means for rotating the abrasive means connected to the rotating spindle, as well as mechanical means for linking to a robot, the mechanical linkage being of type ball joint with pin.

Furthermore, when moulding and machining a plastic part, the edge line of the part may deform locally in the direction of the thickness, especially by bending during machining. This may happen in particular when the part is thin.

Consequently, the trajectory to be followed by the grinding wheel is different from the theoretical preprogrammed trajectory.

This difference between the true and theoretical trajectories may also occur when the part is not perfectly positioned with respect to the geometrical reference frame of the part support and the robot.

Surprisingly, the equipment according to the invention overcomes this problem. Due to the ball joint with pin mechanical linkage, the non-abrasive mechanical stop and the grinding wheel can follow a true line adaptable with respect to the theoretical programmed line.

According to one embodiment, the guide edge is an edge of the plastic part.

The abrasive means may include a conical section, whose gradient of the rotating spindle with respect to the cone generatrix is adapted to remove the material from an edge of the part by breaking a corner formed between the material to be removed and the edge of the part.

According to this configuration, the gradient of the abrasive means is preferably adapted to guide the edge of the part in order to block it against the non-abrasive section due to the part flexibility.

The abrasive means are preferably diamond-impregnated.

According to another embodiment, the system includes a cutting guide having a cavity of a shape to be produced on the plastic part and forming the guide edge, and on which the non-abrasive section can rest.

According to a variant of this embodiment, the system includes a drill tip on the rotating spindle.

The invention also relates to a robot-controlled system for removing material from a plastic part comprising:
a system for removing material from a plastic part according to the invention;
a robot for controlling the trajectory of the system for removing material, the plastic part remaining fixed.

The invention also relates to a robot-controlled system for removing material from the edge of a plastic part comprising:
a system for removing material from a plastic part according to the invention;
a robot for controlling the trajectory of the plastic part opposite the fixed system for removing material.

Lastly, the invention relates to the use of the system according to the invention for deburring a plastic part and for milling or drilling a plastic part.

The invention will be better understood on reading the following description, referring to the accompanying drawings, which are given solely by way of example and not limiting in any way, in which:

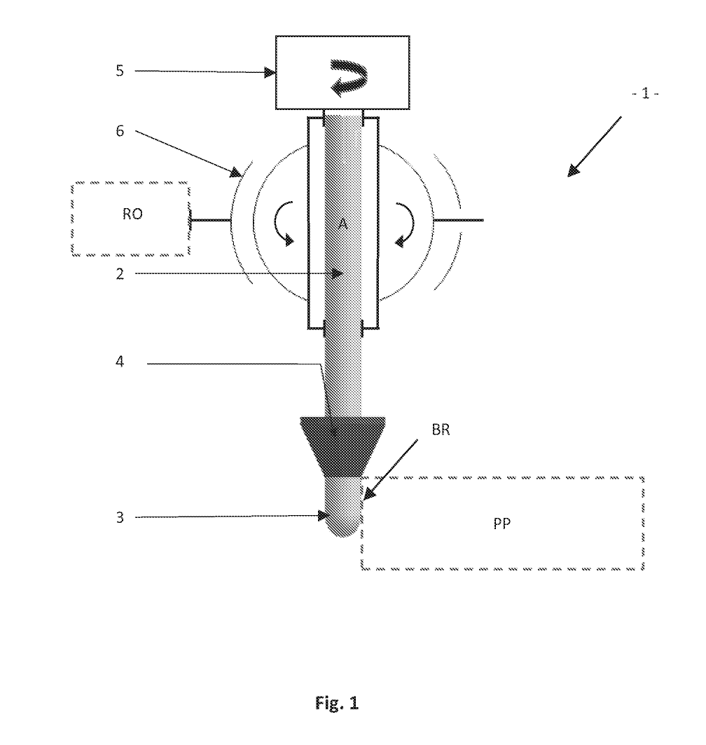

FIG. 1 illustrates an embodiment of the tool according to the invention.

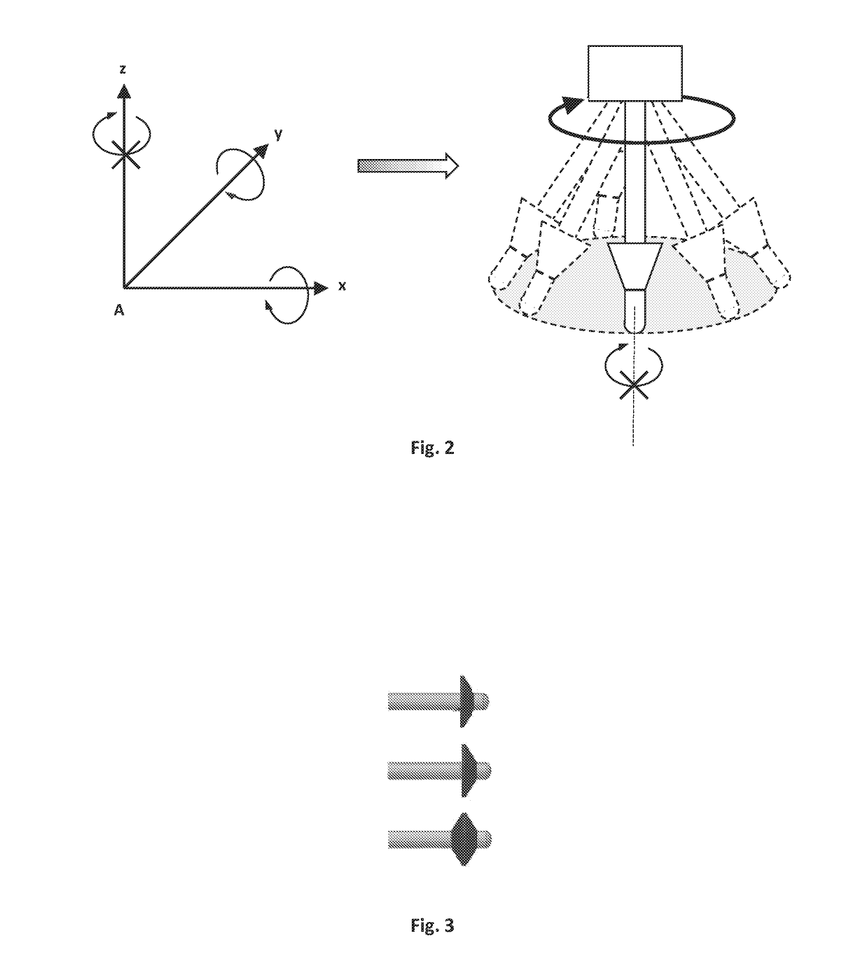

FIG. 2 illustrates the operation of the ball joint with pin mechanical linkage.

FIG. 3 illustrates alternative embodiments, with grinding wheels of different shapes.

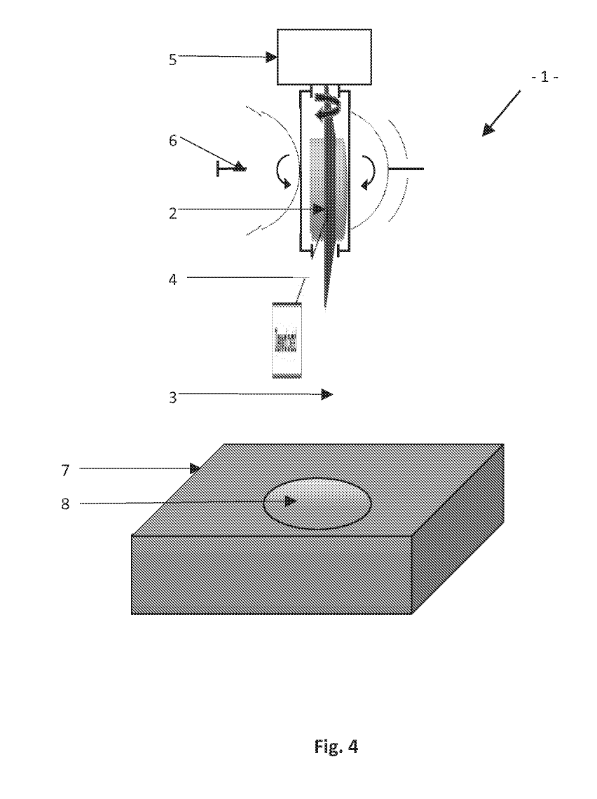

FIG. 4 illustrates an embodiment in which the system for removing material according to the invention further comprises a cutting guide on which the non-abrasive section forming the radial stop can rest.

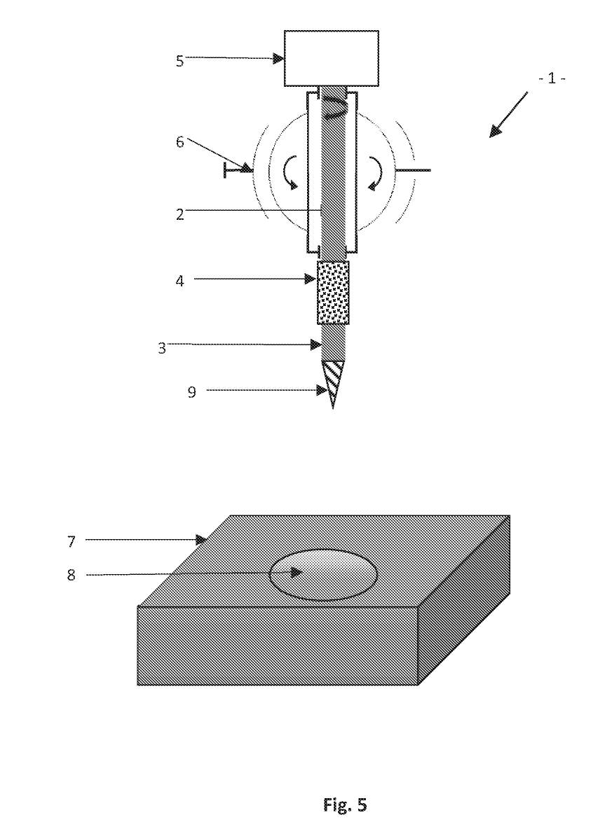

FIG. 5 illustrates an embodiment in which the rotating spindle of the system for removing material according to the invention includes, in addition to the cutting guide, a drill tip to drill through the material.

The invention relates to a system for removing material from a plastic part (PP).

We now refer to FIG. 1 which shows an embodiment of the system (1) according to the invention. This system includes:
a rotating spindle (2) provided with abrasive means (4) and a non-abrasive section (3), this non-abrasive section (3) being designed to form a radial stop (BR) of the system (1) on a guide edge;
driving means (5) for rotating the abrasive means (4) connected to the rotating spindle (2);
mechanical means (6) for linking to a robot, the mechanical linkage being of type ball joint with pin.

The invention is first described in the special case of removal of material on the edges of a plastic part (marked PP on the figures), and more particularly in case of deburring. However, the removal of material may also correspond to milling or drilling for example.

The plastic part may be made of thermoplastic material or thermosetting material, preferably loaded at least with reinforcement fibres (composite material). Preferably, the part is made of a thermosetting composite of type SMC.

The edge of a part designates an external edge forming all or some of the part periphery, or an internal edge resulting from removal of material.

The driving means (5) may be a pneumatic motor for example. It transmits torque to the abrasive means (4). The abrasive means (4) may be a grinding wheel, if deburring an edge of a part.

The system (1) includes mechanical means (6) for linking to a robot (RO). FIG. 2 illustrates the operation of this mechanical linkage (6). This mechanical linkage is of type “ball joint with pin” of centre A and of rotation along the z axis blocked, the z axis being that of the rotating spindle (2). This mechanical linkage (6) is also qualified as “360 degree compliant head”, as opposed to an axially compliant head.

It consists of a ball joint equipped with a pin preventing rotation. Thus, in a plane (x, y, z), the spherical linkage with pin has four degrees of freedom. It links the three translations and one rotation, leaving the other two rotations free.

Thus, rotation of the tool (1) about the z axis—that of the rotating spindle (2)—is blocked by the mechanical linkage (6), between the robot and the tool (1). Inside the tool (1), however, the rotating spindle (2) is rotated about the z axis by the driving means (5).

This type of mechanical linkage allows the use of a constant tangential force setpoint of the tool (1) on the edge of the plastic part (PP), and guarantees permanent contact under this tangential force, irrespective of the edge geometry, and therefore the trajectory of the tool (1).

Apart from improving the quality of the material removal operation, this mechanical linkage (6) makes it easier to programme the tool (1) trajectory which is controlled by a robot, since it allows a displacement of about one centimetre.

Generally, to programme a slightly curved trajectory or to take into account a fault in the positioning of the part on the machining support, a folding or shape fault, the trajectory must be defined by a set of close points through which the robot must send the tool. Due to the ball joint with pin linkage, two points at the start and end of the curve may be sufficient, since the tool absorbs/compensates for any trajectory variations within a tolerance interval.

The rotating spindle (2) includes a non-abrasive section (3) guaranteeing the deburring tangential penetration distance. This non-abrasive section (3) forms a mechanical stop for the tool (1) on a guide edge. According to the example of deburring a part edge, the guide edge is the edge of the part to be deburred. This mechanical stop is called the “guide end”. This non-abrasive section (3) can be positioned at the end of the rotating spindle (2) opposite the driving means (5).

It presses the tool (1) against the edge of the plastic part (PP), without damaging it, while following the edge of the part. This mechanical stop (3) eliminates the problem of the geometric variability of the burrs. Since the abrasion capacity of the abrasive grinding wheel (4) is much greater than the burr thickness, this radial stop (3) prevents uncontrolled penetration of the abrasive grinding wheel (4) into the material. Without this stop (3), the force of the tool on the part would have to be adjusted very precisely to prevent the abrasive grinding wheel (4) from penetrating too far into the material. Due to the precise effect of the mechanical stop (3), in combination with the mechanical linkage (6), a global tangential force can be applied on the edge of the part.

It is therefore easier to calibrate the contact pressure, i.e. the tangential force of the non-abrasive section (3) on the edge of the part, so that the grinding wheel (4) does not penetrate too far into the material. Due to the compliance effect (ball joint with pin mechanical linkage) the rotating spindle (2) pivots, thereby compensating for pressure variations.

To deburr an automotive part, a tangential force of 80 N was sufficient to remove all the burrs without damaging the part itself.

The spindle (2) carries an abrasive grinding wheel (4) above or below the stop (3). The grinding wheel (4) is preferably diamond-impregnated.

According to one embodiment, the grinding wheel (4) includes a conical section, whose gradient of the rotation axis with respect to the cone generatrix is adapted to:
remove the material (the burr) from the edge of the part by breaking the corner formed between the burr and the part edge;
guide the part edge to block it against the mechanical stop (3) due to the flexibility in the thickness (along the z axis) of the part.

The grinding wheel (4) can also have any convex or concave revolution shape. FIG. 3 illustrates various alternative embodiments, with grinding wheels (4) of different shapes and, in particular, a shape of two cones assembled by their bases.

The system (1) according to the invention can be used for any type of method for removing material, such as deburring, milling or drilling.

Currently, to produce cutouts in plastic parts, made in particular of thermosetting material, either six-axis robot machining or punching is used.

With the first technique, the cutouts (round, oblong holes, special shapes) are produced by moving a milling cutter with a six-axis robot. The positioning tolerance for this type of installation is generally about +/−1 mm and the shape tolerance about +/−0.5 mm. This lack of precision is largely due to the faults and flexibility of the robot and a long chain of dimensions from the milling cutter to the machined hole: milling cutter->machining spindle->robot->turntable->part support->part->machined hole.

With the second technique, although the positions and shapes of the cutouts are generally precise (about +/−0.45 and +/−0.2), the tooling is specific (single product) and all the cutouts must be made in the same direction (punching direction).

According to a second embodiment (FIG. 4), especially well adapted to milling, and which overcomes these constraints, the system for removing the material according to the invention further comprises a cutting guide (7) on which the non-abrasive section (3) forming a stop can rest.

The cutting guide (7) is a part with a cavity (8) of the shape to be produced. In this case, the non-abrasive section (3) goes inside the cavity (8) to follow the contours thereof, thereby transmitting the trajectory to the abrasive means (4). Thus, the guide edge is no longer the edge of the part (PP), but the edge of the cavity (8). The abrasive means (4) is a milling cutter for example.

One advantage of this embodiment is to allow greater positioning tolerance for the tool (1) carried by the robot, since the material removal trajectory is then guided locally by the cutting guide (7).

Furthermore, the local and precise guiding results in a shape that is not disturbed by the shape tolerance (due to the global imprecision of the robot position).

According to a third embodiment (FIG. 5), a variant of the second embodiment and especially well adapted to drilling, the rotating spindle (2) of the system for removing material (1) according to the invention includes, in addition to the cutting guide (7), a drill tip (9) to drill through the material.

When using this system, the cutting guide (7) is positioned on the machining support next to the shape to be cut out. The drill tip (9) allows the abrasive means (4) to drill through the material. The abrasive means (4) moves down until the non-abrasive section (3) touches the cavity (8) of the cutting guide (7). The abrasive means (4) is moved until the non-abrasive section (3) presses against the edge of the cavity (8) of the cutting guide (7). The ball joint with pin mechanical linkage (6) allows the non-abrasive section (3) forming a radial stop to remain permanently in contact with the cutting guide (7), while following the cavity (8). The robot (RO) moves along the contour of the cutout and the non-abrasive section (3) is kept pressed against the guide (7) throughout the displacement. After making the cutout, the robot (RO) moves away from the part (PP).

The invention also relates to a robot-controlled system for removing material, for example on the edges of a plastic part (PP), comprising a system for removing material (1) according to the invention, mounted on a robot (RO), preferably an anthropomorphic robot, to control the trajectory of the device.

The robot (RO) is used as a means for handling the tool (1) guaranteeing good repeatability in terms of tool orientation (of the order of the degree), positioning (less than one mm) and speed.

Using the system according to the invention, there is no need for the robot (RO) to turn around itself with its cables: the ball joint with pin mechanical linkage (6) allows the tool to follow the entire trajectory while remaining in contact with the edge of the part (PP).

According to a variant, the robot (RO) controls the trajectory of the system (1) for removing material according to the invention, this system therefore being mobile and the plastic part (PP) remaining fixed.

According to a variant, the robot (RO) carries the plastic part (PP) and controls the trajectory of the part (PP) opposite the system (1) for removing material according to the invention, this system (1) remaining fixed.

1. System for removing material from a plastic part, comprising a rotating spindle provided with abrasive means, wherein:
the rotating spindle includes a non-abrasive section, which can form a radial stop for the system on a guide edge; and in that it includes
driving means for rotating the abrasive means connected to the rotating spindle; and
mechanical means for linking to a robot, the mechanical linkage being of type ball joint with pin.

2. System according to claim 1, wherein the guide edge is an edge of the plastic part.

3. System according to claim 1, wherein the abrasive means include a conical section, whose gradient of the rotating spindle with respect to the cone generatrix is adapted to remove the material from an edge of the part by breaking a corner formed between the material to be removed and the edge of the part.

4. System according to claim 1, wherein the gradient of the abrasive means is adapted to guide the edge of the part in order to block it against the non-abrasive section due to the part flexibility.

5. System according to claim 1, wherein the abrasive means are diamond-impregnated.

6. System according to claim 1, comprising a cutting guide having a cavity of a shape to be produced on the plastic part and forming the guide edge, and on which the non-abrasive section can rest.

7. System according to claim 1, comprising a drill tip on the rotating spindle.

8. Robot-controlled system for removing material from a plastic part comprising:
a system for removing material from a plastic part according to claim 1;
a robot for controlling the trajectory of said system for removing material, the plastic part remaining fixed.

9. Robot-controlled system for removing material on the edge of a plastic part comprising:
a system for removing material from a plastic part according to claim 1;
a robot for controlling the trajectory of the plastic part opposite the fixed system for removing material.

10. Use of the system according to one of claim 1, for deburring a plastic part.

11. Use of the system according to claim 1, for milling or drilling a plastic part.
